(19) United States
(12) Patent Application Publication
(10) Pub. No.: US 2019/0102704 A1
(43) Pub. Date: Apr. 4, 2019

(54) MACHINE LEARNING SYSTEMS FOR RANKING JOB CANDIDATE RESUMES

(71) Applicant: Wei Liu, Redmond, WA (US)

(72) Inventor: Wei Liu, Redmond, WA (US)

(21) Appl. No.: 16/150,139

(22) Filed: Oct. 2, 2018

Related U.S. Application Data
(60) Provisional application No. 62/566,780, filed on Oct. 2, 2017.

(51) Int. Cl. G06N 99/00; G06N 5/02; G06Q 10/10

(52) U.S. Cl. CPC G06N 99/005; G06Q 10/1053; G06N 5/022

(57) ABSTRACT

A machine learning system for ranking job candidates' resumes based on a predictive system comprising machine learning from a large number of resume profile data sets, job opening requirements data sets, and relevant employer HR data. The machine learning system includes a resume data training engine that receives a plurality of resume profile data, job opening requirements data, and relevant employer HR data. The received data is used to determine a plurality of features and generate a predictive model. The system also includes a resume ranking runtime engine that utilizes the predictive model to generate ranking data regarding a plurality of resume records data using the predictive model based on received job description data and resume records data.

### TECHNICAL FIELD

The present disclosure relates to automated systems for ranking resumes from job applicants based on machine learning techniques and providing interviewing and hiring recommendations.

### BACKGROUND

### Description of the Related Art

Currently, it takes tremendous resources for employers to find suitable candidates to fill in different types of job openings. The traditional hiring procedures are typically performed as follows: an employer receives job applicants' resumes, which are submitted online, through an agent, or mailed/emailed in; the resumes are filtered and a short list of candidates is selected for phone or on-site interviews; hiring decisions are reached after one or more rounds of interviews and the successful candidates are offered job positions. It is not uncommon that hundreds, sometimes thousands of resumes, are submitted for one job opening. Accordingly, the human resources (HR) field generally involves reviewing, evaluating, and ranking job candidate resumes as an initial step in resume filtering and screening.

There are many existing systems to facilitate filtering and sorting resumes. Almost all existing systems focus on extracting, transforming, and loading (ETL) resumes first, then retrieving/parsing resume data before using these data directly to find correlations between the resume data and the job posting requirements. In these systems, data records, such as schools, past employers, or skills mentioned in the resumes are matched against a preselected list of job requirements from employers. Those systems then score or rank the resumes based on these data matches. The use of these existing resume processing systems overlooks much of the interrelations among relevant data, such as the job-related data for each individual applicant over time (e.g., how applicants advance in their careers, what employers and locations applicants have been choosing, etc.), interrelationships between all these applicants' education and work history (e.g., specific educational background such as major or certificate, and what kind of past employers are more relevant for a specific job opening), and employers' internal interviewing and hiring records. These isolated, word-matching-based systems simply cannot provide heuristic insights from each candidate's resume nor provide predictive analysis of each candidate's fitness and potentials for specific job positions.

Recently, some systems and methods have been designed with added personality tests, technical tests, or question assessments to supplement candidate resume information. However, these additional assessments are used as more or less another layer of filters in existing systems. As a result, much of the resume review process still relies on HR-designed or HR-selected filtering criteria.

### BRIEF SUMMARY

The present disclosure describes a machine learning system for ranking job candidates' resumes based on a predictive system comprising means of performing training using a large number of resume profile data sets, job opening requirements data sets, and relevant employer HR data based on machine learning techniques.

A machine learning system for ranking a plurality of resumes may be summarized as including a resume data training engine, including a first set of one or more processors; and at least one nontransitory processor-readable medium that stores first processor executable instructions, that when executed by the first set of one or more processors, cause the first set of one or more processors to: receive a plurality of resume profile data; receive a plurality of job opening requirements data; receive data regarding past recruitment events; determine a plurality of features from the plurality of resume profile data and the plurality of job opening requirement data; and generate a predictive model by employing one or more machine learning algorithms to train from the plurality of features, the plurality of resume profile data, the plurality of job opening requirements data, and the data regarding past recruitment events; and a resume ranking runtime engine, including a second set of one or more processors; and at least another one nontransitory processor-readable medium that stores second processor executable instructions, that when executed by the second set of one or more processors, cause the second set of one or more processors to: receive the predictive model from the resume data training engine; receive job description data for a new job position; receive a plurality of resume records data for candidates applying to for the new job position; generate ranking data regarding the plurality of resume records data using the predictive model based on the received job description data and resume records data; and present the ranking data to a user.

The resume data training engine may further receive employer human resources (HR) data that is used together with the plurality of resume profile data for training. The employer HR data may include a plurality of employee profile data or past hiring data, as well as other hiring- or employment-related data, such as recruitment or hiring data, employee data, etc. Each of the plurality of employee profile data may include personal information data, location data, education data, skills data, or work experience data. The past hiring data may include one or more past hiring events data, each of the one or more past hiring event data comprising a plurality of resume data received and corresponding hiring decisions. Each of the plurality of resume profile data may include personal information data, location data, education data, skills data, or work experience data. The education data may include school attended, degree, GPA, major, or awards. Each of the work experience data may include employer, location, title, duty, or compensation.

The ranking data of the plurality of resume records data may further include annotations for one or more resume records data. The annotations may include hiring recommendation information or reasoning information for a respective ranking score.

The ranking data of the plurality of resume records data may be transmitted to the resume data training engine to cause the resume data training engine to perform further training and modify the predictive model. The transmission of the ranking data from the resume ranking runtime engine to the resume data training engine may be transmitted immediately after it is available. The transmission of the ranking data from the resume ranking runtime engine to the resume data training engine may be transmitted periodically. The job description data may include title, location, education, skills, experience, or compensation. Feedback data from one or more users of the machine learning system regarding previous resume ranking results may be transmitted to the resume data training engine for further training.

A computer-implemented machine learning method for ranking a plurality of resumes may be summarized as including receiving a plurality of resume profile data from a plurality of historic resumes; receiving a plurality of job opening requirements data for a plurality of historic job openings associated with the plurality of historic resumes; receiving past recruitment events data; determining a plurality of features from the plurality of resume profile data and the plurality of job opening requirement data; employing machine learning to train and generate a predictive model from the plurality of resume profile data, the plurality of job opening requirements data, the past recruitment events data, and plurality of features; receiving new job description data for a new job opening; receiving a plurality of resume records data for the new job opening; generating ranking data regarding the plurality of resume records data using the predictive model based on the received new job description data and plurality of resume records data; and presenting the ranking data to a user.

The method may further include receiving employer HR data that is used together with the plurality of resume profile data for training the predictive model. The employer HR data may include a plurality of employee profile data or past hiring data. Each of the plurality of the employee profile data may include personal information data, location data, education data, skills data, or work experience data. The past hiring data may include one or more past hiring events data, each of the one or more past hiring event data comprising a plurality of resume data, and corresponding hiring decisions. Each of the resume profile data may include personal information data, location data, education data, skills data, or work experience data. The education data may include school attended, degree, GPA, major, or awards. Each of the work experience data may include employer, location, title, duty, or compensation.

The ranking data of the plurality of resume records data may further include annotations for one or more resume records data. The annotations may include hiring recommendation information or reasoning information for a respective ranking score. The ranking data of the plurality of resume records data may be used for further training of the predictive model. The job description data may include title, location, education, skills, experience, or compensation. Feedback data regarding previous resume ranking results may be used for further training.

A non-transitory computer-readable medium storing computer readable instructions that, when executed by one or more processors, perform a machine learning method which may be summarized as including receiving a plurality of resume profile data from a plurality of historic resumes; receiving a plurality of job opening requirements data for a plurality of historic job openings associated with the plurality of historic resumes; receiving past recruitment events data; determining a plurality of features from the plurality of resume profile data and the plurality of job opening requirement data; employing machine learning to train and generate a predictive model from the plurality of resume profile data, the plurality of job opening requirements data, the past recruitment events data, and plurality of features; receiving new job description data for a new job opening; receiving a plurality of resume records data for the new job opening; generating ranking data regarding the plurality of resume records data using the predictive model based on the received new job description data and plurality of resume records data; and presenting the ranking data to a user.

The method may further include receiving employer HR data that are used together with the plurality of resume profile data for training.

The ranking data of the plurality of resume data may be used by a resume data training engine for further training.

Feedback data regarding previous resume ranking results may be used for further training.

### BRIEF DESCRIPTION OF THE DRAWINGS

Implementations are described herein with reference to the following drawings. However, it is to be understood that the implementations are not limited to the specific methods and apparatus depicted herein.

FIG. 1 illustrates a network environment according to an implementation of the present disclosure;

FIG. 2A illustrates a system diagram according to an implementation of the present disclosure;

FIG. 2B illustrates an example computer structure setup for the system described herein;

FIG. 3 illustrates a flowchart of the training process according to an implementation of the present disclosure;

FIG. 4 illustrates a flowchart of the resume ranking process according to an implementation of the present disclosure;

FIG. 5A illustrates a diagram showing the operation of the Resume Data Training Engine according to an implementation of the present disclosure;

FIG. 5B illustrates a diagram showing the operation of the Resume Data Training Engine using a neural network algorithm according to an implementation of the present disclosure; and

FIG. 6 illustrates a time sequence diagram of the resume ranking process according to an implementation of the present disclosure.

### DETAILED DESCRIPTION

The following example implementations are merely illustrative and should not be considered limiting. All the components disclosed could be implemented exclusively in software, exclusively in hardware, or in any combinations of hardware and software using known techniques. Apart from what is disclosed herein, there are numerous possible means to implement the present disclosure.

Throughout this disclosure, processed resumes refer to resumes containing data that has been processed and is presented in a structured way to enable resume processing systems to perform further processing. “Raw” resumes are resumes that are presented in its original unstructured formats, text based or image based. Each of all servers referred to in this disclosure typically comprise one or more processors, a memory device, an input interface, and an output interface. Each server may also comprise one or more databases, or is connected to one or more databases, internally or externally.

Briefly, aspects described herein utilize machine learning techniques to explore deep connections inside job-related resume data and incorporate relevant employer HR data—such as feedback data of previous applicant ranking events, results of employer's past hiring events, employee performance data, data from external (public or private) sources regarding any relevant hiring or ranking events—to provide better recommendations and rankings of applicants' resumes to employers, which dynamically adjusts and improves the resume processing system.

The traditional “workflow-like” systems inherit numerous disadvantages due to the lack of feedback insights and lack of ability to self-improve over time. Some applications using various machine learning techniques, such as supervised machine learning and reinforcement learning, can provide extra data patterns learned from training large amount of known results, which can be helpful for systems to get optimized results and superb performance.

For example, consider the scenario of an employer trying to evaluate a candidate with the right skill sets but who just quit his previous job after one year of employment and who has a history of quitting jobs within two years. Because the existing systems only consider isolated or “snapshot” information regarding an applicant's qualifications on the resumes, this applicant would probably keep showing up on top of the short list because his skills match the job requirements. For an employer looking for a candidate hoping that he/she stays in a position for a relatively long period, this situation could result in resources wasted—if this candidate were interviewed, hired, and then quit his job soon.

In other scenarios, the same candidate should possibly be placed on top of other resume search results, such as possibly from start-ups, who are looking for people with the right skill sets and are willing to take more risks in the job market in exchange for project experience and short-term higher potential rewards. Applying a word-matching or questionnaire filtering/sorting may not adequately cope with the increasing complexity of job requirements and resume drafting techniques.

Utilizing the machine learning approach described herein presents a processing system with the ability to “learn” from resumes and relevant employer HR data that a stable position should probably ignore candidates who tend to leave employers within two years, while also favoring better skill sets in more volatile positions. The processing system can also use new data from employers that hired similar job-moving tendencies before to enhance or confirm learned patterns of candidate employment periods, which can improve the accuracy of future filtering/ranking efforts.

The machine-learning approach described herein provides a more intelligent, efficient, self-learning, next-generation system that learns from “past” resume and job information (e.g., education, work experience, career path, company preferences, location preferences, etc.) to predict “future” employment needs (e.g., job performance, position fitness, company culture fitness, location preferences, etc.) and improve itself with relevant employer HR data.

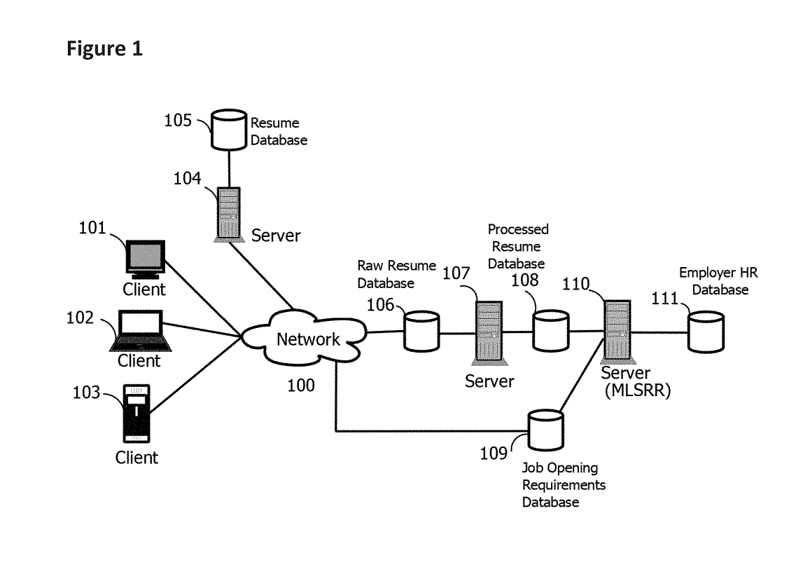

FIG. 1 shows a system diagram in a network environment according to an implementation of the present disclosure. Individual users may utilize a personal computer 101 or 102, a mobile device 103, or any other communications devices (not illustrated) to submit resumes to Raw Resume Database 106 via communications network 100. Alternatively, a server 104 that is connected, internally or externally, to a Resume Database 105, may also be connected to the communication network 100 to provide a plurality of resumes, “raw” or processed to the Raw Resume Database 106. A server 107 receives raw resumes from the Raw Resume Database 106 and processes the resumes. The processed resumes are stored in a Processed Resume Database 108. Note that processed resumes may be directly passed from an external database such as the Resume Database 105 to the Processed Resume Database 108. A server 110 contains a Machine Learning System for Resume Ranking (MLSRR) according to the present disclosure. The MLSRR receives processed resume data from database 108, and job opening requirements (JOR) data from a JOR database 109, as its input. The MLSRR may also receive data from external databases such as an Employer Human Resource (HR) Database 111 from an employer, which stores all relevant employer HR data, e.g., job-related data of employees and past recruitment data, as input data. Note that the JOR data may be obtained from data mining on the internet, derived from external resume databases, provided by one or more employers, transmitted directly from the Employer HR Database 111, or some combination thereof. The results of resume processing of MLSRR are presented to a user of the server 110, and may be transmitted back to the Employer HR Database 111.

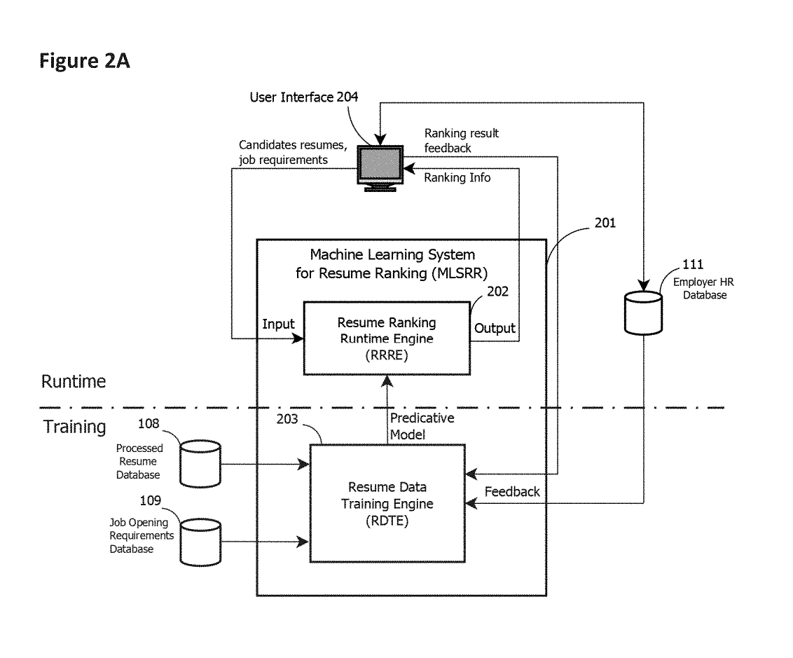

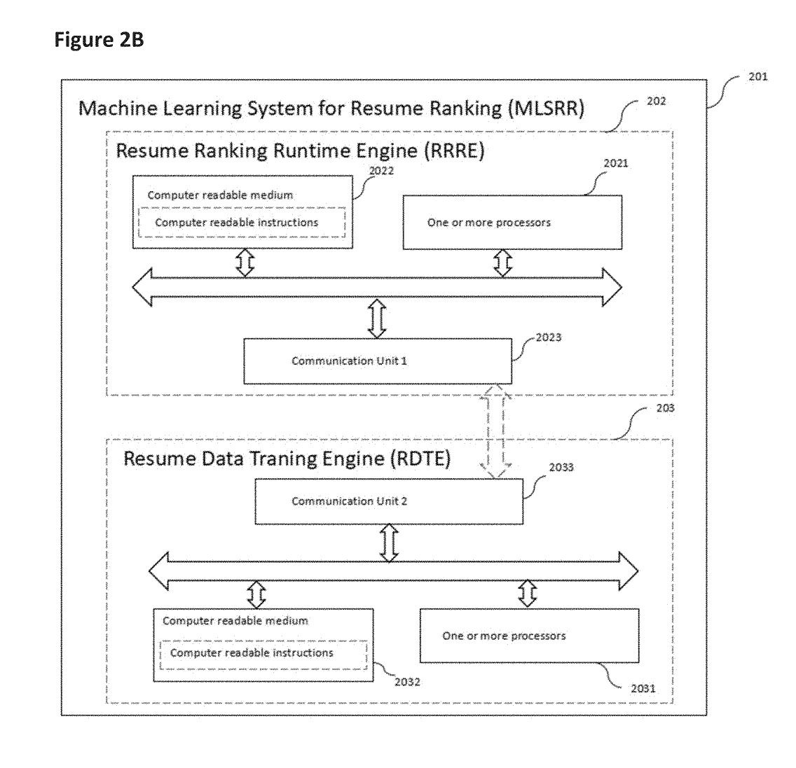

FIG. 2A illustrates a diagram of an implementation of the present disclosure. As mentioned in FIG. 1, the server 110 includes an MLSRR, which is illustrated as a Machine Learning System for Resume Ranking (MLSRR) 201 in FIG. 2A. The MLSRR 201 may be a software module of a server, a standalone software system, or a hardware implemented component. Sometimes, an employer is already equipped with an existing resume filtering tool (ERFT) (not shown) to process raw resume data and perform basic filtering, such as from an Application Tracking System (ATS). In some implementations, where employers do not have an existing resume processing system, the functions of the ERFT may also be incorporated into the MLSRR 201 and become a module inside MLSRR (not shown).

The MLSRR 201 comprises two components: a Resume Data Training Engine (RDTE) 203 and a Resume Ranking Runtime Engine (RRRE) 202. The RDTE 203 is used for performing training using job-related data in the training stage. And the RRRE 202 is used for ranking lists of resume records in an operational environment.

In an implementation, the RDTE 203 receives a list of a plurality of resume records from the Processed Resume Database 108, a list of a plurality of job opening requirements (JOR) data from the JOR Database 109, and data from the Employer HR database 111 as inputs for training purposes. The list of resume records and JOR data may be obtained from internal or external resources, locally or remotely; updated real-time or periodically. The list of resume records, JOR data, and employer data are utilized, as described herein, to train a predictive model using machine learning techniques. After each round of training with any new or updated inputs, the RDTE 203 generates an updated predictive model as a result. The predictive model is passed to the RRRE 202 for runtime operations.

The RRRE 202 is a runtime engine that receives a list of a plurality of resume records and a plurality of job opening requirements (JOR) data. The RRRE 202 processes these data sets using the predictive model provided by the RDTE 203, and generates ranking information for the list of resume records. The resume records and JOR data sets may be obtained from internal or external resources, such as from a user interface 204, provided by a user (e.g., a recruiter, an HR personnel from an employer, etc.). Each of the resume records may include information related to education data, previous employment data, publication data, location data, technical skills data, and any other related data. Each of the JOR data sets may include information such as job title, location, education requirements, skills requirements, work experience requirements, etc.

The results of resume ranking processes are typically presented to a user through a user interface, such as 204. The resulted ranking information, such as which candidates are interviewed or hired based on the ranking information and which candidates are rejected, together with the inputted JOR data sets and resume records, are also transmitted to the RDTE 203 for further training, which improves the performance of the RDTE 203 over time. This feedback transmission may be real-time, e.g., right after the ranking information is available, or may be processed periodically, such as on a daily or weekly basis.

The RDTE 203 may also use information from the Employer HR Database 111 for further training purposes. The Employer HR Database 111 includes data on employees or positions, which may include profiles and performances of one or more existing employees, information on one or more past hiring events and hiring decisions, and other job-related data. The Employer HR Database 111 may also include job or hiring related data obtained from external sources such as the Internet or external databases for training purposes.

FIG. 2B illustrates an example computer structure setup for the system described herein. The RDTE 203 may include a first set of one or more processors 2031; and at least one non-transitory processor-readable medium 2032 that stores first processor executable instructions. The RDTE 203 may also include a communication unit 2033. The set of one or more processors 2031 can communicate to the processor readable medium 2032 via a bus, that when executed by the first set of one or more processors 2031, cause the first set of one or more processors 2031 to perform at least some of the embodiments described herein, including to: receive a plurality of resume profile data; receive a plurality of job opening requirements data; receive data regarding past recruitment events; determine a plurality of features from the plurality of resume profile data and the plurality of job opening requirement data; and generate a predictive model by employing one or more machine learning algorithms to train from the plurality of features, the plurality of resume profile data, the plurality of job opening requirements data, and the data regarding past recruitment events.

A resume ranking runtime engine RRRE 202 may include a second set of one or more processors 2021; and at least another one non-transitory processor-readable medium 2022 that stores second processor executable instructions. The RRRE 202 may also include a communication unit 2023. The set of one or more processors 2021 can communicate to the processor readable medium 2022 via a bus, that when executed by the second set of one or more processors 2021, cause the second set of one or more processors 2021 to perform at least some of the embodiments described herein, including to: receive the predictive model from the resume data training engine RDTE 203; receive job description data for a new job position; receive a plurality of resume records data for candidates applying to for the new job position; generate ranking data regarding the plurality of resume records data using the predictive model based on the received job description data and resume records data; and present the ranking data to a user.

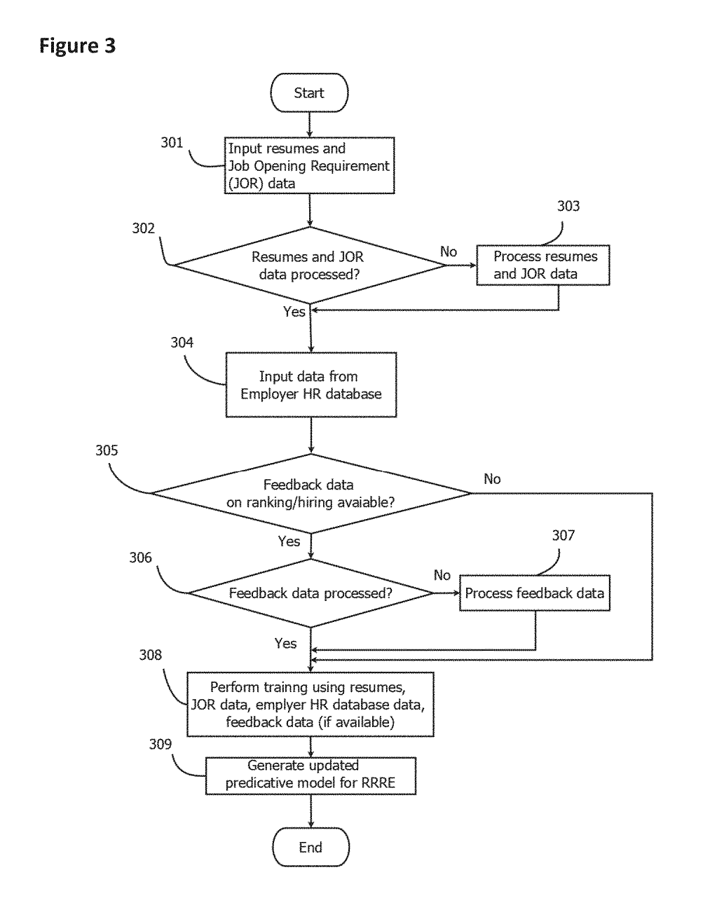

FIG. 3 shows a flowchart of the present disclosure. In step 301, resume data and JOR data is received by the system. In step 302, the system checks if the resume and JOR data is processed, e.g., presented as structured data with parameters ready to be parsed by the RDTE 203. If the resume data is not processed, it is sent to a job data clean module (not shown) to be processed (step 303). In step 304, data from the Employer HR database is obtained for training purposes. In step 305, the system checks if there is feedback data regarding past resume ranking and hiring processes (ranking results, interview comments, hiring decisions, etc.) available. If the feedback data is available, the system checks if the relevant data is processed at step 306. If not, the feedback is processed by the job data clean module in step 307. In step 308, the processed data and other received data is used for training by the RDTE 203. In step 309, the RDTE 203 generates an updated predictive model for the RRRE 202.

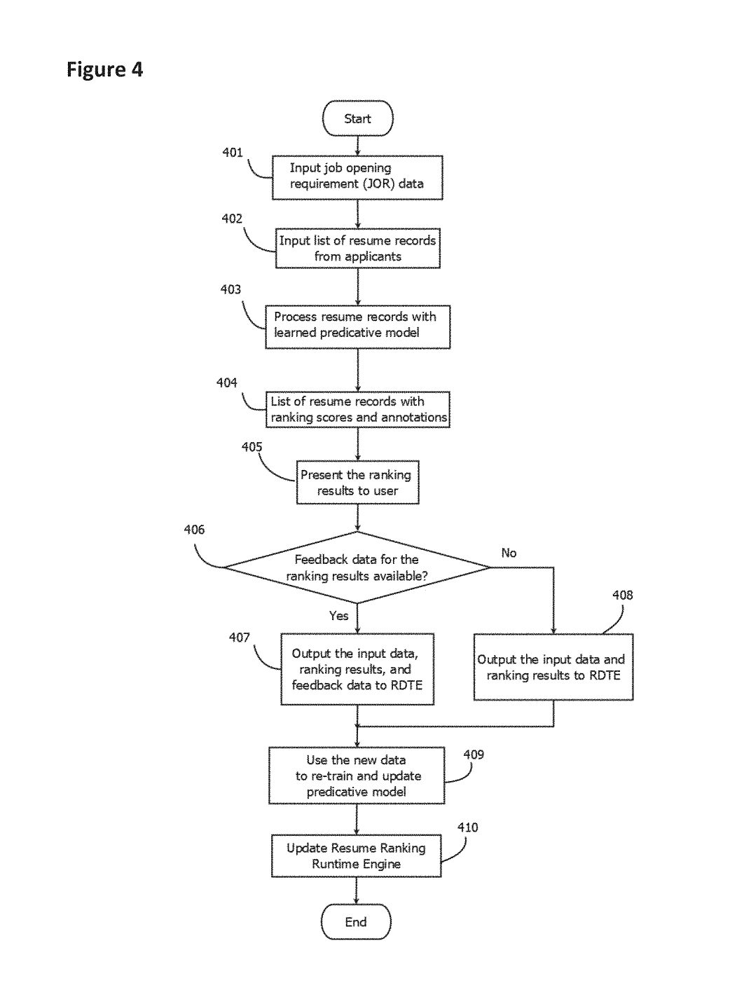

Referring to FIG. 4, when processing a request to rank a list of resume records, one or more job opening requirements records are received at the RRRE 202 in step 401. In step 402, a list of resume records from candidates, which is to be ranked, is provided to the RRRE 202. In step 403, the Resume Ranking Runtime Engine 202 uses the predictive model received from the RDTE 203, which comprises ranking algorithms that are resulted from the machine learning in the training stage, to process the resumes based on the JOR records. In step 404, the ranking result data is generated, including ranking information, and automatically generated annotations or flags to identify information that is important. The ranking result data is presented to the user in step 405. In step 406, the RRRE 202 checks if a user provides feedback data regarding the ranking results. If the feedback data is available, the inputted resume/JOR records data, ranking results data, and the feedback data is passed to the RDTE 203 for further training (step 407). If the feedback data is not available, the inputted resume/JOR records data and ranking results data are passed to the RDTE 203 for further training (step 408). In step 409, the RDTE 203 uses the newly acquired data to perform further training and generate an updated predictive model. In step 410, the updated predictive model is passed to the RRRE 202. This resume ranking process can be executed for several rounds until a decisive event happens (e.g., a hiring decision is made or the job opening is closed).

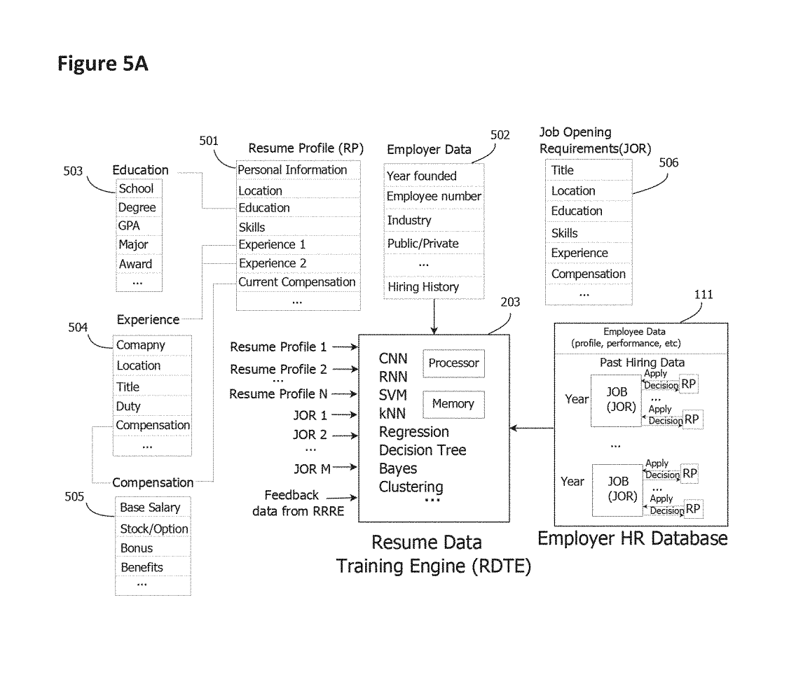

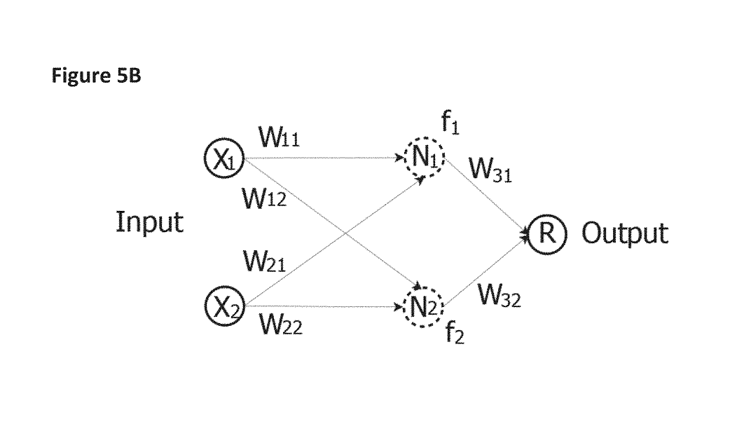

FIG. 5A shows how the training engine RDTE 203 works. The input data of the training engine includes a large number of processed resume profile data sets 501, a large number of processed job opening requirements data sets 506, employer data 502, and job or hiring related data from the Employer HR Database 111. Each resume profile data 501 typically comprises data fields such as (1) personal information, which may comprise contact numbers, mailing address, email address, and social media accounts, etc.; (2) current location; (3) education 503, which may comprise schools attended, degrees or diploma earned, GPAs, major, awards, publication list, etc.; (4) a plurality of work experience 504, which may comprise employer name, title, location, responsibilities, compensation details, etc.; (5) current compensation details; (6) any other related data, or any combination thereof. Note that the “compensation” data 505 may include base salary, stocks/options, bonuses, benefits, etc. The job-related data from the Employer HR Database 111 may include a plurality of employee profile data, each of which may have a similar structure with the resume profile data 501, past hiring events data including hiring decisions data, other job-related data, job or hiring related data obtained from external sources such as the Internet or external databases for training purposes, or any combination thereof. Each of the past hiring data may include a job description, all the applicants' resume profile data, decision data regarding the interviews, acceptances or rejections for each of the applicants, the hired employee's performances, or any combination thereof.

The RDTE 203 also utilizes feedback data from the RRRE 202 for training purposes. The feedback data may comprise data from resume ranking activities, including inputted resume records data; JOR data; ranking results data; or any combination thereof. The feedback data may also comprise updated Employer HR database.

With all the training data, the RDTE 203 may utilize one or more machine learning algorithms to “learn” how to process and rank resume profiles. The algorithm applied may be one or combination of a deep learning technique, a neural network algorithm such as Convolutional Neural Network (CNN) and Recurrent Neural Network (RNN), a Support Vector Machines (SVM) algorithm, a k-nearest neighbors algorithm (kNN), a regression algorithm such as linear regression algorithm, a decision tree algorithm, a Bayes algorithm such as naïve Bayes algorithm, and other machine learning algorithms. The result of the pre-training process may be a predictive model comprising one or more ranking algorithms to the used by the RRRE 202.

An example training process is described here. Firstly, a number of features to be used in the training are selected or extracted, which may include job history data learned from the resume data for each applicant, education data, skills data, work experience data, location data, and any other related data. The feature extraction may be implemented manually before the training stage, or maybe performed by an automatic feature extraction algorithm, many of which are known in the art. For example, an unsupervised machine learning algorithm may be used to perform clustering of features and feature extractions. Secondly, the features are used in the training process using one or more above-mentioned machine learning algorithms. A simple example is to assign initial weights to different features and adjust these weights automatically and iteratively during the training stage with a large number of data sets based on machine learning algorithms such as CNN or RNN. The purpose of training is to produce a predictive model comprising a number of target functions. The predictive system typically receives a job description and a list of resume profile data and produces resume ranking data as a result. During training, all kinds of job related data connections and aspects are “learned” and incorporated into the predictive system. For example, from the large number of data sets the machine could learn that job applicants from around a specific location are not likely to move out of that specific location (i.e., Silicon Valley), which is indicated in their resume data; while job applicants working in a certain field tend to move out of specific locations within five years after they start jobs in that location (i.e., an oil field). Another example could be that for a certain renowned company, a large percentage of the employees are graduated from a small number of universities. These two examples show that location and education information in the resumes could provide more important insightful information than the “snapshot” data of these resumes. When features are processed and deep connections are learned, different weights maybe assigned to each feature or a combination of features, iteratively.

### Training Example 1

Regarding the above-mentioned examples, the weights could be assigned, including relocation willingness weight W₁ and school index weight W₂, which as defined below.

relocation willingness weight W₁=(W_{—high} if (location is A) and (job field is B))

or

(W_{—low} (if location is C) and (job field is D))

Many known machine learning algorithms, such as a regression algorithm, may be implemented to learn and know how to classify a location in a resume to W_{—high} or W_{—low}. For example, after training with past hiring event data, the predictive model learns that last job location being in the Silicon Valley plus job field being Internet technologies would classify a resume's W₁ to W_{—high}. A binary classification algorithm may be used, taking applicant's current location or distance to the job post, and job field as two input features, with past successful and or unsuccessful candidates from past hiring events as training data, to output a high score or low score.

school index weight W₂=W₂ₐ (if school is from group 1 for corporation X)

or

W_{2b} (if school is from group 2 for corporation X

or

W₂ₙ (if school is from group n for corporation X)

Again, many known machine learning algorithms, such as multiclass classification algorithms, may be implemented to get W₂ from a resume. For example, after training with past hiring event data, the training module learns that graduates from Stanford University have a higher rate to be hired by company X, which would classify a resume's W₂ to W_{—2a}. In this case, the input of the machine learning algorithm is the school code and company identification, and output is a weight or score after the classification model.

These examples are merely for illustrative purposes, as there are numerous job-related features can be used in the system described herein to train the predictive model based on the input resume and requirements data. Moreover, while using certain machine learning techniques, for example, deep learning or clustering, unexpected data connections/features/patterns may be found among the different types of resume data. These connections/features/patterns are also incorporated in the resulting predictive system to produce more accurate results. At this stage, the predictive system would know how to classify different features of a resume and generate corresponding weights. As an example, a ranking score can be generated by adding all the weights up and multiplying the sum by an constant value, which can be output to a user indicating a relevancy of the corresponding resume.

### Training Example 2

Another example to perform training is to utilize all features in a single machine learning algorithm, such as a neural network algorithm, to perform training and obtain a predictive model. For example, the features may include (1) years of work experience, (2) years stayed in current/last job position, (3) distance to the location of the job post, (4) number of skills matched with the job description, (5) frequency of job changes in the past 10 years, (6) education level, (7) or other resume features that are common to the training resume data.

To illustrate this, a fully connected neural network may be used to train the training data, which may include data from past hiring events. In this case, a weight would be assigned between any two of the selected features. How the weights are set would be the results of training. To reduce computational complexity when many features are selected, a CNN algorithm may be used to perform training with better efficiency.

In one non-limiting use case example, only two features are used to illustrate how the training may be implemented, as shown in FIG. 5B. The two features in use are “years stayed in current/last job position” (feature X₁), and “frequency of job changes in the past 10 years” (feature X₂). Suppose there is one two-node hidden layer (node N₁ and node N₂), fully connected with the two input nodes, each of the node N₁ and node N₂ utilizes activation functions f₁(X₁, W₁₁, X₂, W₂₁) and f₂(X₁, W₁₂, X₂, W₂₂), respectively. f₁ and f₂ may be a sigmoid function or a multiclass classification function, or any suitable function known in the art. The output is a ranking function R(f₁*W₃₁, f₂*W₃₂), which could be as simple as R( )=f₁*W₃₁+f₂*W₃₂, or any suitable functions. During training, data regarding “years stayed in current/last job position” and “frequency of job changes in the past 10 years” of multiple successful candidates in the past are used to train the model and adjust the weights. After many iterations of training, the predictive model would be accurate enough to be used in the runtime engine. For example, the model may learn that “less than two years stayed in last job position combined with more than 5 times job changes in the past 10 years” would produce a very low ranking score for a specific company based on their past hiring data.

The above example only uses two features. In a real production environment, dozens of or even hundreds of features (automatically extracted or manually defined) can be used to generate the ranking score, using similar neutral network settings. In the cases with a large number of features, a CNN or RNN algorithm may be more efficient. Moreover, a large number of hidden layers may be employed to achieve more accurate results.

After the training stage, the Resume Ranking Runtime Engine 202 is updated with the learned predictive model and ready to be used for resume ranking.

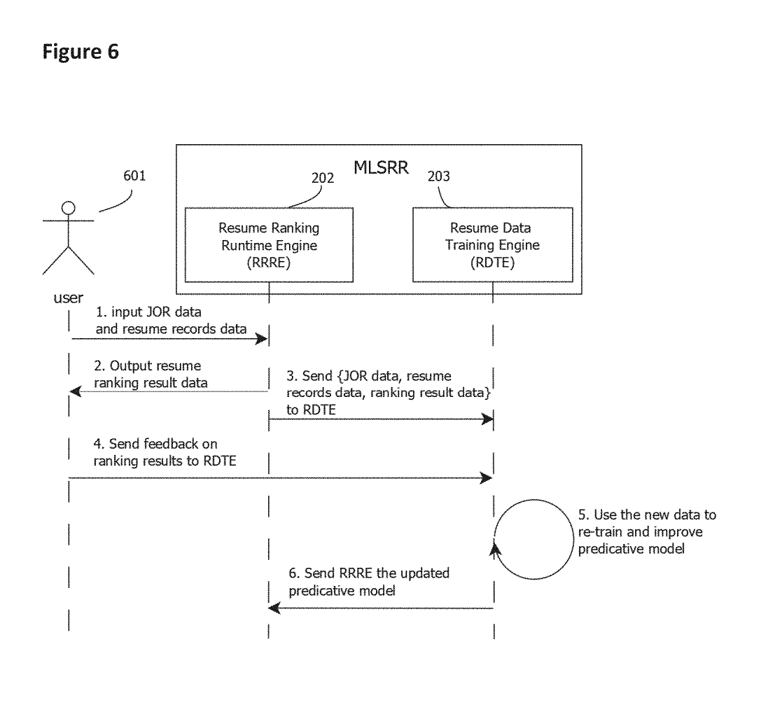

Referring to FIG. 6, a time sequence diagram of the resume ranking process is shown. Firstly, a user 601, who may be a Human Resource staff from a hiring employer, may input one or more JOR data sets and resume records data from all applicants of one or more job openings into the MLSRR, such as MLSRR 201 in FIG. 2A (step 1). The Resume Ranking Runtime Engine 202 in the MLSRR receives and processes the data using the ranking algorithms before outputting the resume ranking information back to the user (step 2). After step 2, the JOR data, resume records data, and ranking results data are also transmitted to RDTE 203 inside MLSRR for further training (step 3). Alternatively, these data sets are saved in an intermediate storage unit (not shown) inside the MLSRR, and is transmitted to the RDTE 203 periodically to reduce operational overheads. For example, the collection of resume ranking data may be transmitted to the RDTE 203 on an hourly, daily, weekly, or monthly basis, depending on the usage of MLSRR. Optionally, if available, feedback data on ranking results from user 601 is also sent to the RDTE 203 for further training (step 4). When the RDTE 203 receives data from the RRRE 202, it performs further training to incorporate what it “learned” from the latest ranking processes (step 5). The resulted predictive model is used to update the predictive model in the RRRE 202 before processing next round of ranking of this JOR, or other resume ranking tasks (step 6).

The Resume Ranking Runtime Engine (RRRE) 202 is a real-time system for ranking resumes. It comprises a processor, an interface to receive inputs, and an output interface. Before performing the resume ranking tasks, the RRRE 202 is updated by the RDTE 203 with a predictive model, as described herein.

During a resume ranking operation, the input interface receives one or more sets of job opening requirements (JOR) for one or more job openings and a plurality of resume records data. Note that the resume records data may be submitted by the job applicants or collected via internal/external resources. The JOR data sets are analyzed or processed to contain structured data comprising features that can be recognized by the RRRE 202. Depending on the features contained in the JOR data sets, one or more functions in the predictive model are activated and start to process the feature data. For example, in a typical neural network algorithm such as that depicted in FIG. 5B, the adjusted weights generated by the training may work together with activation functions to produce a final score for each resume record. Additionally, the predictive model may also generate annotations or flags for one or more of the resume records for the user to review. For example, annotations may be reasoning why a particular resume is ranked near the bottom of the list. As an example, the reasoning could be “5 jobs during the past 20 years in New York City, not likely to relocate to California”, or “10 years on the position of software developer, not likely to succeed as a software architect”. An example flag data could be “resume fits the current employer but not the current position—possible candidate for future hiring”, or “Applied for positions in this employer for more than 10 times in the past.” The annotations may be derived from automatically examining patterns learned during the training. In some situations, it may not be possible to generate annotations for certain resume records depending on word choice or resume complexity.

After the ranking is completed, the Resume Ranking Runtime Engine 202 presents a user a list of resume records with ranking scores, together with optional annotations or flags for some of the resume records. The ranking results data, together with the inputted resume records and JOR data, are transmitted to the RDTE 203 for future training to improve the predictive system, as described herein.

Although certain implementations of the present disclosure have been disclosed herein, they are provided merely for the purposes of explanations and illustrations and are in no way to be constructed as limiting. Various modifications and other implementations are intended to be included within the scope of this disclosure. All terms used in this disclosure are used in a generic and descriptive sense only and not for purposes of limitation. It is intended that the present disclosure not be limited to the implementations disclosed herein, but that the disclosure will include all implementations within the scope of the appended claims.

What is claimed:

1. A machine learning system for ranking a plurality of resumes, comprising:
a resume data training engine, comprising:
a first set of one or more processors; and
at least one nontransitory processor-readable medium that stores first processor executable instructions, that when executed by the first set of one or more processors, cause the first set of one or more processors to:
receive a plurality of resume profile data;
receive a plurality of job opening requirements data;
receive data regarding past recruitment events;
determine a plurality of features from the plurality of resume profile data and the plurality of job opening requirement data; and
generate a predictive model by employing one or more machine learning algorithms to train from the plurality of features, the plurality of resume profile data, the plurality of job opening requirements data, and the data regarding past recruitment events; and
a resume ranking runtime engine, comprising:
a second set of one or more processors; and
at least another one nontransitory processor-readable medium that stores second processor executable instructions, that when executed by the second set of one or more processors, cause the second set of one or more processors to:
receive the predictive model from the resume data training engine;
receive job description data for a new job position;
receive a plurality of resume records data for candidates applying to for the new job position;
generate ranking data regarding the plurality of resume records data using the predictive model based on the received job description data and resume records data; and
present the ranking data to a user.

2. The machine learning system of claim 1, wherein the resume data training engine further receives employer human resources (HR) data that is used together with the plurality of resume profile data for training.

3. The machine learning system of claim 2, wherein the employer HR data comprises a plurality of employee profile data or past hiring data.

4. The machine learning system of claim 3, wherein each of the plurality of employee profile data comprises personal information data, location data, education data, skills data, or work experience data.

5. The machine learning system of claim 3, wherein the past hiring data comprises one or more past hiring events data, each of the one or more past hiring event data comprising a plurality of resume data received and corresponding hiring decisions.

6. The machine learning system of claim 1, wherein each of the plurality of resume profile data comprises personal information data, location data, education data, skills data, or work experience data.

7. The machine learning system of claim 6, wherein the education data comprises school attended, degree, GPA, major, or awards.

8. The machine learning system of claim 6, wherein each of the work experience data comprising employer, location, title, duty, or compensation.

9. The machine learning system of claim 1, wherein the ranking data of the plurality of resume records data further comprises annotations for one or more resume records data.

10. The machine learning system of claim 9, wherein the annotations comprise hiring recommendation information or reasoning information for a respective ranking score.

11. The machine learning system of claim 1, wherein the ranking data of the plurality of resume records data is transmitted to the resume data training engine to cause the resume data training engine to perform further training and modify the predictive model.

12. The machine learning system of claim 11, wherein the transmission of the ranking data from the resume ranking runtime engine to the resume data training engine is transmitted immediately after it is available.

13. The machine learning system of claim 11, wherein the transmission of the ranking data from the resume ranking runtime engine to the resume data training engine is transmitted periodically.

14. The machine learning system of claim 1, wherein the job description data comprises title, location, education, skills, experience, or compensation.

15. The machine learning system of claim 1, wherein feedback data from one or more users of the machine learning system regarding previous resume ranking results is transmitted to the resume data training engine for further training.

16. A computer-implemented machine learning method for ranking a plurality of resumes, comprising:
receiving a plurality of resume profile data;
receiving a plurality of job opening requirements data;
receiving past recruitment events data;
determining a plurality of features from the plurality of resume profile data and the plurality of job opening requirement data;
employing machine learning to train and generate a predictive model from the plurality of resume profile data, the plurality of job opening requirements data, the past recruitment events data, and plurality of features;
receiving new job description data for a new job opening;
receiving a plurality of resume records data for the new job opening;
generating ranking data regarding the plurality of resume records data using the predictive model based on the received new job description data and plurality of resume records data; and
presenting the ranking data to a user.

17. The computer-implemented machine learning method of claim 16, wherein the method further comprises receiving employer HR data that is used together with the plurality of resume profile data for training the predictive model.

18. The computer-implemented machine learning method of claim 17, wherein the employer HR data comprises a plurality of employee profile data or past hiring data.

19. The computer-implemented machine learning method of claim 18, wherein each of the plurality of the employee profile data comprises personal information data, location data, education data, skills data, or work experience data.

20. The computer-implemented machine learning method of claim 18, wherein the past hiring data comprises one or more past hiring events data, each of the one or more past hiring event data comprising a plurality of resume data, and corresponding hiring decisions.

21. The computer-implemented machine learning method of claim 16, wherein each of the resume profile data comprises personal information data, location data, education data, skills data, or work experience data.

22. The computer-implemented machine learning method of claim 21, wherein the education data comprises school attended, degree, GPA, major, or awards.

23. The computer-implemented machine learning method of claim 21, wherein each of the work experience data comprises employer, location, title, duty, or compensation.

24. The computer-implemented machine learning method of claim 16, wherein the ranking data of the plurality of resume records data further comprises annotations for one or more resume records data.

25. The computer-implemented machine learning method of claim 24, wherein the annotations comprise hiring recommendation information or reasoning information for a respective ranking score.

26. The computer-implemented machine learning method of claim 16, wherein the ranking data of the plurality of resume records data is used for further training of the predictive model.

27. The computer-implemented machine learning method of claim 16, wherein the job description data comprises title, location, education, skills, experience, or compensation.

28. The computer-implemented machine learning method of claim 16, wherein feedback data regarding previous resume ranking results is used for further training.

29. A non-transitory computer-readable medium storing computer readable instructions that, when executed by one or more processors, perform a machine learning method comprising:
receiving a plurality of resume profile data;
receiving a plurality of job opening requirements data;
receiving past recruitment events data;
determining a plurality of features from the plurality of resume profile data and the plurality of job opening requirement data;
employing machine learning to train and generate a predictive model from the plurality of resume profile data, the plurality of job opening requirements data, the past recruitment events data, and plurality of features;
receiving new job description data for a new job opening;
receiving a plurality of resume records data for the new job opening;
generating ranking data regarding the plurality of resume records data using the predictive model based on the received new job description data and plurality of resume records data; and
presenting the ranking data to a user.

30. The non-transitory computer-readable medium of claim 29, wherein the method further comprises receiving employer HR data that are used together with the plurality of resume profile data for training.

31. The non-transitory computer-readable medium of claim 29, wherein the ranking data of the plurality of resume data are used by a resume data training engine for further training.

32. The non-transitory computer-readable medium of claim 29, wherein feedback data regarding previous resume ranking results is used for further training.
